(19) United States
(12) Patent Application Publication
(10) Pub. No.: US 2011/0217007 A1
(43) Pub. Date: Sep. 8, 2011

(54) OPTICAL CONNECTOR KIT

(75) Inventors: Yasunari Kawasaki, Matsudo-shi (JP); Masayuki Jibiki, Matsudo-shi (JP)

(73) Assignee: Seikoh Giken Co., Ltd, Matsudo-shi (JP)

(21) Appl. No.: 13/040,108

(22) Filed: Mar. 3, 2011

(30) Foreign Application Priority Data
Mar. 4, 2010 (JP) 2010-047875

(51) Int. Cl. G02B 6/38

(52) U.S. Cl. 385/72

(57) ABSTRACT

The present disclosure relates generally to an optical connector kit including parts constituting an optical connector. Certain embodiments relate to an optical connector kit having an optical fiber with a ferrule, a plurality of connector units, and a storage case including an upper and lower housing.

### CROSS-REFERENCE TO RELATED APPLICATIONS

This application claims priority to and the benefit of Japanese Patent Application No. 2010-047875, filed on Mar. 4, 2010, in the Japan Patent Office. The disclosure of the foregoing application is incorporated herein in its entirety by reference.

### BACKGROUND

1. Field

The present invention relates to an optical connector kit including parts constituting an optical connector, which facilitates an operation of attaching an optical connector to the distal end of an optical fiber on-site.

2. Description of the Related Art

In recent years, to realize construction of access networks, local optical wiring or the like using optical fibers, there has been a demand to attach an optical connector to the distal end of an optical fiber on-site where workability is restricted as compared to manufacturing factories.

Generally, an optical connector can have a lot of parts. During the attachment of an optical connector to the distal end of an optical fiber, the optical connector parts may need to be first manually passed through the optical fiber one by one.

Thus, particularly when the attachment operation is performed on-site, operation errors often occur when some of the connector parts are not passed through the optical fiber, or when the connector parts are passed through the optical fiber in a wrong order or a wrong direction. It takes time and care to pass the connector parts through the optical fiber even though it is a simple operation, thereby deteriorating the workability.

To solve the problem, Japanese Patent Application Publication No. 2005-25132 discloses a case which stores a plurality of connector parts to be passed through an optical fiber in advance when an optical connector is attached to the distal end of the optical fiber, the connector parts being arranged in a line in the order in which the connector parts are passed through the optical fiber.

Conventional optical connector parts cases attempt to prevent the occurrence of the operation error when some of the connector parts are not passed through the optical fiber or when the connector parts are passed in a wrong order or a wrong direction.

### SUMMARY

Conventional optical connector parts case designs can have a problem in that each set of a type of optical connectors requires a corresponding optical connector part case. Thus, a variety of optical connector part cases are required to be kept on hand for various sets of optical connector parts. Accordingly, manufacturing equipment investment increases and inventory control is complicated, thereby contributing to cost increases.

Accordingly, there is a need for an optical connector kit in which a variety of optical connector parts are stored in one type of case.

In one embodiment, there is provided an optical connector kit. The optical connector kit comprises a ferrule-with-optical-fiber obtained by mounting a short optical fiber into a ferrule in advance and polishing an end surface of said optical fiber, a plurality of connector parts (insertion parts) to be passed through another optical fiber in advance before a rear end of said short optical fiber and a distal end of said another optical fiber are fusion-spliced, and a storage case for storing all connector parts constituting an optical connector, which include the ferrule-with-optical-fiber and the insertion parts, wherein the insertion parts are arranged in a line in the order in which the insertion parts are passed through said another optical fiber, the storage case comprises a lower housing and an upper housing in an openable and closeable manner, optical fiber insertion ports, through which said another optical fiber can be inserted from outside on one side of the lower housing to outside on the other side of the lower housing through the insertion parts, are provided in both side walls of the lower housing, insertion part storage portions for storing the insertion parts are provided in both the lower housing portion and the upper housing portion, and the insertion parts are stored in the insertion part storage portion, and held by sandwiching between the lower housing portion and the upper housing portion.

In another embodiment, tapered shapes for guiding said second optical fiber to be inserted are formed between adjacent insertion part storage portions.

In yet another embodiment, the storage case comprises the lower housing having a bottom surface raised by a surrounding side wall and the upper housing having a lid surface to be coupled together in an openable and closeable manner, wherein the lower housing comprises a flange around a lower portion of the side wall, the upper housing comprises a flange in a surrounding portion, and the upper housing and the lower housing comprise a lower engagement portion and an upper engagement portion engageable with each other.

In yet another embodiment, the flanges of the lower housing and the flange of the upper housing are not brought into close contact with each other when the storage case is closed, so as to be a tab when the storage case is opened.

In yet another embodiment, a storage portion for the ferrule with optical fiber and a storage portion for the insertion parts are formed so as to bulge downward in the bottom surface of the lower housing, and wherein a bulging depth of the storage portion for said individual insertion part is smaller than a height of said corresponding insertion part to be stored therein.

For purposes of summarizing the invention and the advantages achieved over the prior art, certain objects and advantages of the invention have been described above and as further described below. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

These and other aspects of the invention will be readily apparent from the following description and from the appended drawings (not to scale), which are meant to illustrate and not to limit embodiments of the invention, and in which:

FIG. 1 is a plan view illustrating a state in which a storage case storing all connector parts constituting an optical connector is closed according to one embodiment of an optical connector kit;

FIG. 2 is a plan view illustrating a state in which the optical connector kit in FIG. 1 is opened to a partially open state;

FIG. 3 is a plan view illustrating a state in which the optical connector kit in FIG. 1 is opened to a fully open state;

FIG. 4 is a plan view illustrating a state in which an empty storage case storing no connector parts is opened to a fully open state;

FIG. 5 is a right side view of the storage case in FIG. 4;

FIG. 6 is a sectional view illustrating one embodiment of a ferrule-with-optical-fiber used for the optical connector kit;

FIG. 7 is a sectional view illustrating the length of each portion of a short optical fiber used for the ferrule-with-optical-fiber in FIG. 6; and

FIG. 8 is a sectional view illustrating one embodiment of an optical connector obtained by assembling the optical connector kit.

### EXPLANATION OF NUMERICAL REFERENCES

1: optical connector kit
5: storage case
10: ferrule-with-optical-fiber
11: ferrule
12: capillary
13: micro hole
15: flange portion
16: coated portion passage hole
18: short optical fiber
18a: bare optical fiber portion
18b: coated optical fiber
18c: splicing extra length (extended optical fiber portion)
20: connector part (insertion part)
21: boot
22: sleeve
23: stop ring
24: clip
25: spring
28: reinforcement sleeve
30: other connector part (other part)
31: plug frame
32: cap
40: holding member
41: cap
42: pulling portion
50: lower housing
51: bottom surface
52: side wall
53: flange
54: tab
55: upper housing
56: lid surface
57: flange
58: tab
60: ferrule-with-optical-fiber storage portion
61: ferrule storage portion (the lower portion)
61′: ferrule storage portion (the upper portion)
62: optical fiber protection portion
65: holding member storage portion (the lower portion)
65′: holding member storage portion (the upper portion)
66: cap storage portion
67: pulling portion storage portion
68: finger hooking portion
70: insertion part storage portion (the lower portion)
70′: insertion part storage portion (the upper portion)
71: boot storage portion (the lower portion)
71′: boot storage portion (the upper portion)
72: sleeve storage portion (the lower portion)
72′: sleeve storage portion (the upper portion)
73: stop ring storage portion (the lower portion)
73′: stop ring storage portion (the upper portion)
74: clip storage portion (the lower portion)
74′ : clip storage portion (the upper portion)
75: spring storage portion (the lower portion)
75′: spring storage portion (the upper portion)
76a,76b: optical fiber insertion port
78: reinforcement sleeve storage portion (the lower portion)
78′: reinforcement sleeve storage portion (the upper portion)
79: finger hooking portion
80: other part storage portion
81: plug frame storage portion
82: finger hooking portion
85: cap storage portion
86: finger hooking portion
91: first region
92: second region
94: a plurality of small holes
95,97: lower engagement portion
96,98: upper engagement portion
100: optical connector
101: optical fiber
111,111′: tapered portion

### DETAILED DESCRIPTION OF EMBODIMENTS

The embodiments according to the present invention will now be explained in detail with reference to the drawings, but the present invention is not intended to be limited to these embodiments and many different embodiments can be implemented.

In some embodiments, an optical connector kit can include a ferrule-with-optical-fiber obtained by mounting a short optical fiber into a ferrule in advance and polishing an end surface, a plurality of connector parts (insertion parts) to be passed through another optical fiber in advance before a rear end of said short optical fiber and a distal end of said another optical fiber can be fusion-spliced, and a storage case for storing all connector parts constituting an optical connector, which can include the ferrule-with-optical-fiber and the insertion parts. While connector parts used for the fusion splicing (parts for use in fusion splicing) including the ferrule-with-optical-fiber and the insertion parts can be removed from the storage case, the storage case can hold other connector parts in a stored state. Thus, the storage case can be easily carried to a site. There is also a reduced possibility that a user will forget to carry some of the connector parts constituting the optical connector.

The storage case for storing all the connector parts constituting the optical connector allows a variety of optical connector parts to be stored in one type of storage case. Thus, equipment investment decreases and inventory control is simplified, so that the optical connector kit can be provided at a lower price.

Since the ferrule-with-optical-fiber obtained by mounting the short optical fiber into the ferrule in advance and polishing the end surface is employed, an operation of fusion-splicing the rear end of the short optical fiber and the distal end of said another optical fiber on-site is facilitated.

Moreover, the storage case can hold the other connector parts in a stored state while the parts for use in fusion splicing can be removed therefrom. Thus, the other connector parts used after the fusion-splicing operation are not possibly missing from the storage case during the fusion-splicing operation.

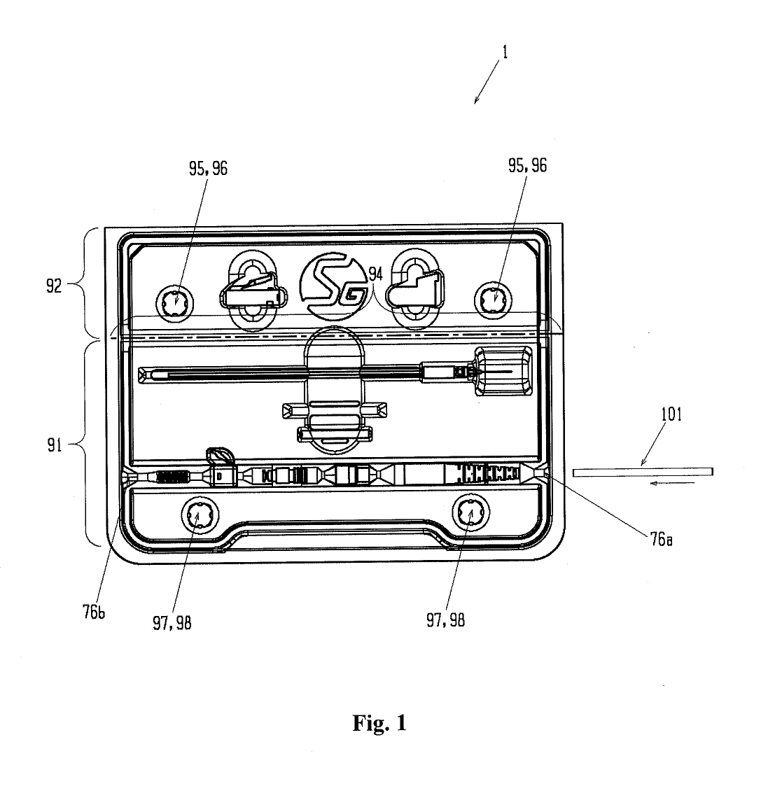

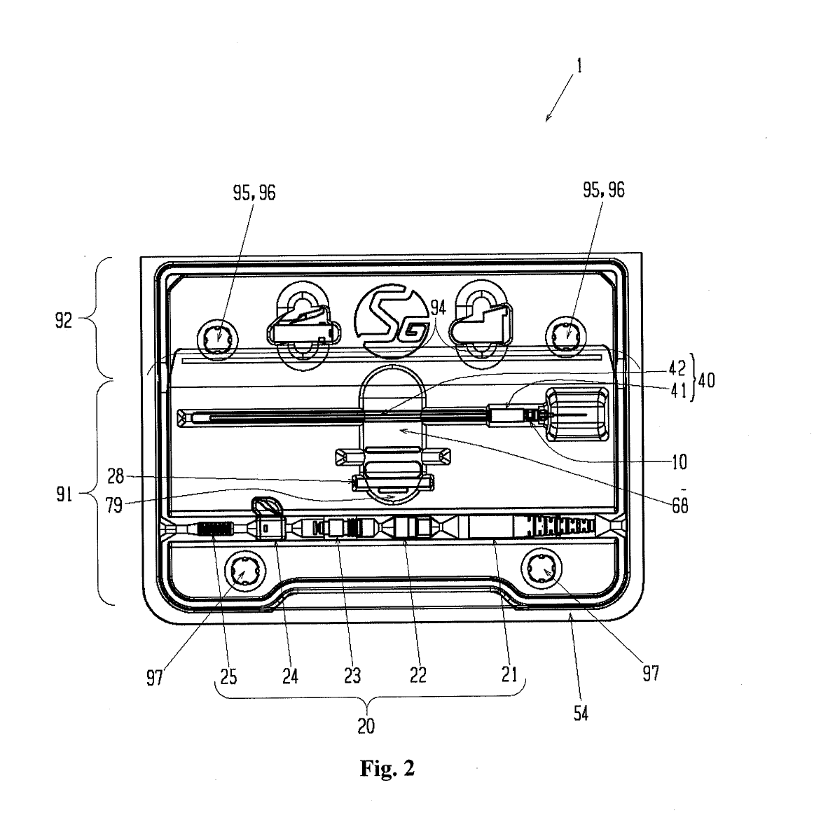

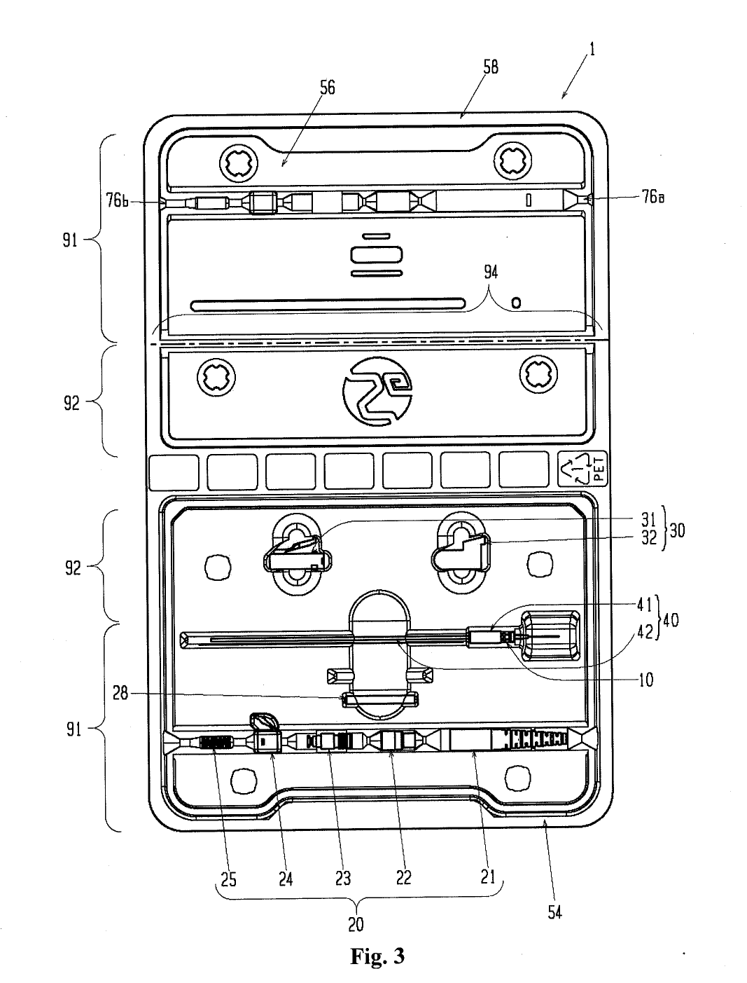

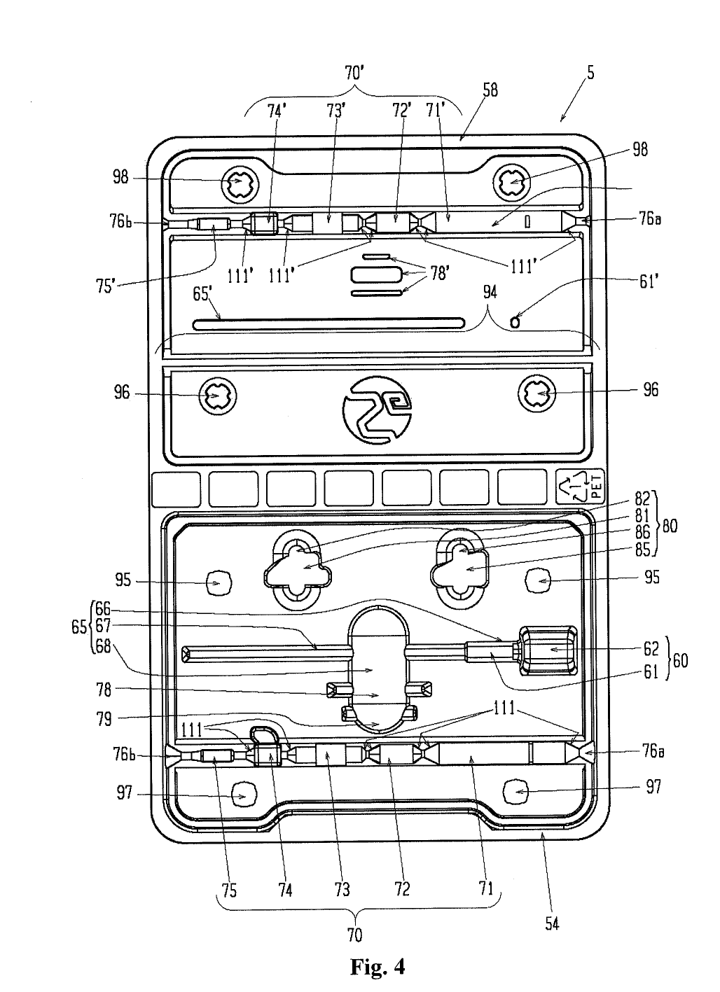

FIG. 1 is a plan view of an embodiment of an optical connector kit illustrating a state in which a storage case storing all connector parts is closed. FIG. 2 is a plan view illustrating a state in which the storage case is opened to a partially open state. FIG. 3 is a plan view illustrating a state in which the storage case is opened to a fully open state. FIG. 4 is a plan view illustrating a state in which an empty storage case storing no connector part is opened to a fully open state.

In the optical connector kit 1, all the connector parts which can constitute an optical connector, which can include a ferrule-with-optical-fiber 10 obtained by mounting a short optical fiber into a ferrule in advance and polishing an end surface, can be stored in a storage case 5.

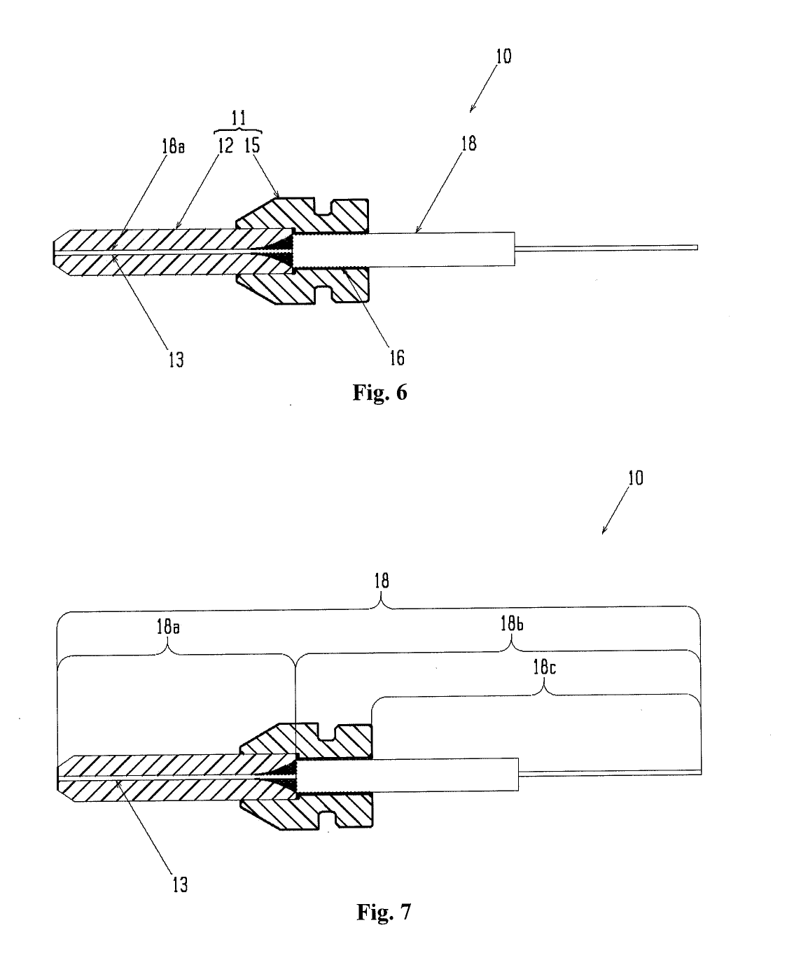

As shown in FIG. 6, the ferrule-with-optical-fiber 10 can include a ferrule 11 having a capillary 12 and a flange portion 15 for holding a rear end portion of the capillary 12. A short optical fiber 18 having a bare optical fiber portion 18a, from which a coating is removed, at the distal end can be mounted into the ferrule 11, and the end surface can be polished.

A micro hole 13 can be formed throughout the capillary 12 from the distal end to the rear end to store the bare optical fiber portion 18a of the short optical fiber 18.

A coated portion passage hole 16 can be formed in the flange portion 15 to store a coated optical fiber 18b.

When the bare optical fiber portion 18a is stored in and secured to the micro hole 13 of the capillary 12, and the coated optical fiber 18b leading from the bare optical fiber 18a is stored in and secured to the coated portion passage hole 16, the short optical fiber 18 can extend backward by a required splicing extra length 18c from the coated portion passage hole 16 of the flange portion 15.

The splicing extra length 18c extending backward from the flange portion 15 can have at least a length required by an unillustrated fusion splicing apparatus which optically connects the rear end of the splicing extra length 18c and the distal end of another optical fiber 101 (see FIG. 1) to which the rear end can be optically connected.

Although the splicing extra length 18c of the short optical fiber 18 may be left as the coated optical fiber 18b, a coating in the rear end portion may be removed as shown in FIGS. 6 and 7.

As a countermeasure against strength deterioration occurring when the short optical fiber 18 is kept for a long period at normal temperature and normal humidity when stored in the optical connector kit 1, and to improve static fatigue characteristics, a coating of metal or carbon, that is, a hermetic coating such as a metal or carbon coating can preferably be applied to the outer periphery of the short optical fiber 18.

In addition to the ferrule-with-optical-fiber 10, the connector parts constituting the optical connector include a plurality of connector parts (insertion parts) 20 to be passed through the optical fiber 101 in advance before the rear end of the short optical fiber 18 and the distal end of the optical fiber 101 can be fusion-spliced as shown in FIG. 3.

That is, the insertion parts 20 can include a boot 21, a sleeve 22, a stop ring 23, a clip 24 and a spring 25 as shown in FIG. 3. The ferrule-with-optical-fiber 10, the insertion parts 20, and a reinforcement sleeve 28 constitute connector parts that can be used for fusion splicing (parts for use in fusion splicing).

The reinforcement sleeve 28 can reinforce a fusion-spliced portion obtained when the rear end of the short optical fiber 18 and the distal end of the optical fiber 101 are fusion-spliced. A heat-shrinkable tube including a reinforcement member of metal or the like and thermoplastic resin can constitute the reinforcement sleeve 28.

The connector parts constituting the optical connector can also include other connector parts (other parts) 30 in addition to the parts for use in fusion splicing 10, 20 and 28. To be more specific, the other connector parts (the other parts) 30 can include a plug frame 31 and a cap 32 as shown in FIG. 3.

The storage case 5 in which all the connector parts constituting the optical connector as described above are stored can also store a holding member 40 for holding the ferrule-with-optical-fiber 10 during fusion splicing.

The holding member 40 can include a cap 41 where the ferrule 11 of the ferrule-with-optical-fiber 10 can be inserted from the distal end, and a pulling portion 42 extending from a bottom portion of the cap 41. The holding member 40 can be integrated with the ferrule-with-optical-fiber 10 when the ferrule 11 is inserted into the cap 41. The rear end of the short optical fiber 18 of the ferrule-with-optical-fiber 10 and the distal end of the optical fiber 101 can be fusion-spliced in this state. After that, the holding member 40 can be detached from the ferrule 11.

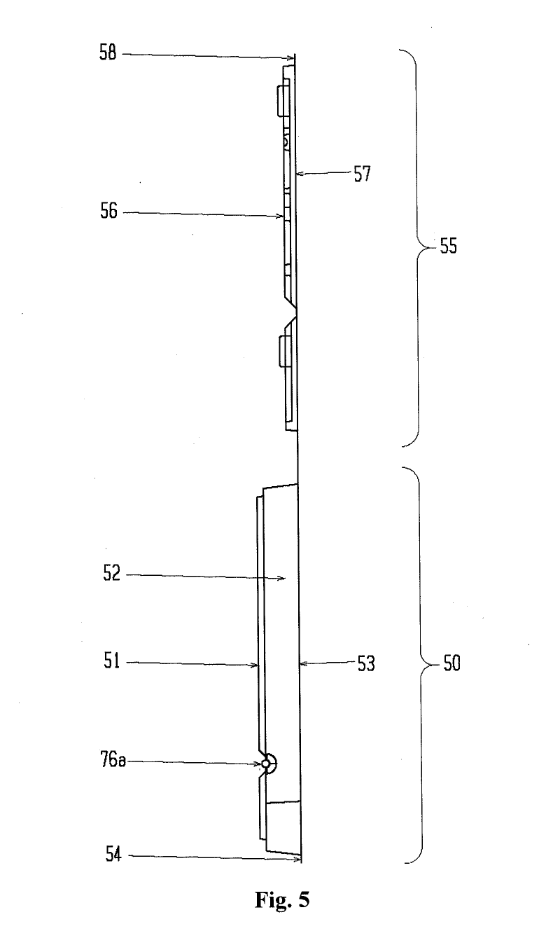

As shown in FIG. 5, the storage case 5 can include a lower housing 50 having a bottom surface 51 raised by a surrounding side wall 52, and an upper housing 55 having a lid surface 56, which are coupled together in an openable and closeable manner.

The lower housing 50 can include a flange 53 around a lower portion of the side wall 52. The upper housing 55 can include a flange 57 at the lid surface 56. Lower engagement portions 95 and 97 of the lower housing 50, and upper engagement portions 96 and 98 of the upper housing 55 can engage with each other.

The storage case 5 also can include tabs 54 and 58 which can be gripped when the storage case 5 is opened, by the flange 53 of the lower housing 50 and the flange 57 of the upper housing 55 not being brought into close contact with each other when the storage case 5 is closed.

In the storage case 5, a ferrule-with-optical-fiber storage portion 60 for storing the ferrule-with-optical-fiber 10, a holding member storage portion (the lower portion) 65 for storing the holding member 40 mounted on the ferrule-with-optical-fiber storage portion 60, an insertion part storage portion (the lower portion) 70 for storing the insertion parts 20 in a line in the order in which the insertion parts 20 are passed through the optical fiber, a reinforcement sleeve storage portion (the lower portion) 78 for storing the reinforcement sleeve 28, and an other part storage portion 80 for storing the other connector parts (the other parts) 30 can be formed so as to bulge downward in the bottom surface 51 of the lower housing 50.

The ferrule-with-optical-fiber storage portion 60 can include a ferrule storage portion (the lower portion) 61 where the ferrule 11 of the ferrule-with-optical-fiber 10 can be stored, and an optical fiber protection portion 62 for forming a space around the optical fiber portion (the splicing extra length) 18c extending from the rear end of the ferrule 11 when the ferrule 11 is stored in the ferrule storage portion (the lower portion) 61.

The optical fiber protection portion 62 protects, with the space as a barrier, the splicing extra length 18c which may have lower strength since the splicing extra length 18c extends from the rear end of the ferrule 11 when the ferrule-with-optical-fiber 10 is stored in the ferrule-with-optical-fiber storage portion 60.

The holding member storage portion (the lower portion) 65 can include a cap storage portion 66 where the cap 41 of the holding member 40 into which the ferrule 11 of the ferrule-with-optical-fiber 10 is inserted can be stored, and a pulling portion storage portion 67 where the pulling portion 42 extending from the bottom portion of the cap 41 can be stored.

The holding member storage portion (the lower portion) 65 can also include a finger hooking portion 68 for allowing a user to hook his finger around the holding member 40, to remove the holding member 40 stored in the holding member storage portion (the lower portion) 65. That is, a user can insert his finger into the finger hooking portion 68 to pull up the pulling portion 42 of the holding member 40, so that the holding member 40 and the ferrule-with-optical-fiber 10 integrated therewith are removed from the storage case 5.

The insertion part storage portion (the lower portion) 70 can include a boot storage portion (the lower portion) 71 where the boot 21 can be stored, a sleeve storage portion (the lower portion) 72 where the sleeve 22 can be stored, a stop ring storage portion (the lower portion) 73 where the stop ring 23 can be stored, a clip storage portion (the lower portion) 74 where the clip 24 can be stored, and a spring storage portion (the lower portion) 75 where the spring 25 can be stored.

The storage case 5 can include optical fiber insertion ports 76a and 76b, through which the optical fiber 101 can be inserted from outside on one side of the storage case 5 to outside on the other side of the storage case 5 through the connector parts (the insertion parts) 20 (the boot 21, the sleeve 22, the stop ring 23, the clip 24, the spring 25) stored in a line, in the both side walls of the storage case 5 on an extension of the insertion part storage portion 70.

The reinforcement sleeve 28 can be stored in the reinforcement sleeve storage portion (the lower portion) 78. The reinforcement sleeve storage portion (the lower portion) 78 can include a finger hooking portion 79 for allowing a user to hook his finger around the reinforcement sleeve 28, to remove the reinforcement sleeve 28 stored in the reinforcement sleeve storage portion (the lower portion) 78. That is, a user inserts his finger into the finger hooking portion 79 to pull up the reinforcement sleeve 28, so that the reinforcement sleeve 28 can be removed from the storage case 5.

The other part storage portion 80 can include a plug frame storage portion 81 where the plug frame 31 can be stored, and a cap storage portion 85 where the cap 32 can be stored. The plug frame storage portion 81 can include a finger hooking portion 82 for allowing a user to hook his finger around the plug frame 31, to remove the plug frame 31 stored in the plug frame storage portion 81. That is, a user inserts his finger into the finger hooking portion 82 to pull up the plug frame 31, so that the plug frame 31 can be removed from the storage case 5.

The cap storage portion 85 can include a finger hooking portion 86 for allowing a user to hook his finger around the cap 32, to remove the cap 32 stored in the cap storage portion 85. That is, a user can insert his finger into the finger hooking portion 86 to pull up the cap 32, so that the cap 32 can be removed from the storage case 5.

The storage case 5 as described above can be molded of appropriate synthetic resin such as PET (polyethylene terephthalate) resin. In this case, by making the storage case 5 transparent, all the connector parts 10, 20, 28 and 30 stored therein can be confirmed from outside the storage case 5 without opening the storage case 5.

The storage case 5 also can include a first region 91 for storing the parts for use in fusion splicing 10, 20 and 28 on a side apart from a coupled portion between the lower housing 50 and the upper housing 55, and a second region 92 for storing the other connector parts 30 on a side close to the coupled portion as shown in FIGS. 1 to 3.

The upper housing 55 of the storage case 5 can be bent at a border portion between the first region 91 and the second region 92. That is, a plurality of small holes 94 can be formed at a predetermined position of the upper housing 55 including a portion of the lid surface 56.

Accordingly, when the upper housing 55 of the storage case 5 is bent along the plurality of small holes 94, only the first region 91 can be opened. In the storage case 5, the lower housing 50 and the upper housing 55 can be opened and closed, and the upper housing 55 can be switched between a partially open state in which the storage region for the parts for use in fusion splicing of the lower housing 50 (the first region 91) is opened, and a fully open state in which the entire region of the lower housing 50 is opened.

The storage case 5 further can include the lower engagement portions 95 and the upper engagement portions 96 engageable with each other in the second region 92 of the lower housing 50, and the second region 92 of the upper housing 55 (see FIGS. 1, 2 and 4).

The lower engagement portions 95 and the upper engagement portions 96 engage with each other when the storage case 5 is closed (see FIG. 1). When the upper housing 55 is opened to the partially open state, the lower engagement portions 95 and the upper engagement portions 96 still maintain the engagement state (see FIG. 2). When the upper housing 55 is opened to the fully open state, the engagement state is released to enable the fully open state.

The storage case 5 may be switched not only between the partially open state in which only the first region 91 is opened and the fully open state in which both the first region 91 and the second region 92 are opened as described above, but among three or more open states including the partially open state and the fully open state.

The upper housing 55 of the storage case 5 can include an insertion part storage portion (the upper portion) 70′, a reinforcement sleeve storage portion (the upper portion) 78′, a ferrule storage portion (the upper portion) 61′, and a holding member storage portion (the upper portion) 65′.

The insertion part storage portion (the upper portion) 70′ can include a boot storage portion (the upper portion) 71′ where the boot 21 can be stored, a sleeve storage portion (the upper portion) 72′ where the sleeve 22 can be stored, a stop ring storage portion (the upper portion) 73′ where the stop ring 23 can be stored, a clip storage portion (the upper portion) 74′ where the clip 24 can be stored, and a spring storage portion (the upper portion) 75′ where the spring 25 can be stored.

A variety of optical connectors are used on-site. For example, an optical connector for a fusion length of 5 mm has a stop ring outermost diameter of, e.g., φ4.5 mm, and an optical connector for a fusion length of 10 mm has a stop ring outermost diameter of, e.g., φ6.3 mm. The two stop ring outermost diameters have a difference of 1.8 mm. For example, if a storage portion having an appropriate shape for the stop ring having the outermost diameter of φ6.3 mm is used, the optical fiber can be difficult to insert into the stop ring having the outermost diameter of φ4.5 mm. In some embodiments, however, the parts are held by the storage portion of the lower housing and the storage portion of the upper housing, so that the misalignment difference is reduced by half to 0.9 mm. Also, the center to insert the optical fiber is maintained. Thus, even when two parts having different outer diameters are stored in the same storage portion, the optical fiber can be easily inserted into the parts.

When the upper housing is in an open state, each insertion part in the insertion part pressing portion of the upper housing is exposed above the lower housing. Thus, each insertion part can be easily removed even when no finger hooking portion is provided in each insertion part storage portion.

A tapered portion 111 can be provided on the both sides of each part storage portion of the insertion part storage portion (the lower portion) 70 to guide said another optical fiber 101 to be inserted. A tapered portion 111′ can be provided on the both sides of each part pressing portion of the insertion part storage portion (the upper portion) 70′ to guide said another optical fiber 101 to be inserted. The structure to sandwich the insertion parts, and the structure to guide said another optical fiber 101 to be inserted allows a variety of optical connector kits to be stored in one type of storage case 5, so that the optical connector kit can be provided at a lower price.

Next, an optical connector assembling method for assembling an optical connector using the above optical connector kit 1 will be described.

First, in the optical connector kit 1, the ferrule-with-optical-fiber 10 can be stored in the ferrule-with-optical-fiber storage portion 60. The holding member 40 integrated with the ferrule-with-optical-fiber 10 can be stored in the holding member storage portion (the lower portion) 65. The insertion parts 20 (the boot 21, the sleeve 22, the stop ring 23, the clip 24, the spring 25) can be stored in the insertion part storage portion (the lower portion) 70. The reinforcement sleeve 28 can be stored in the reinforcement sleeve storage portion (the lower portion) 78. The other connector parts (the other parts) 30 (the plug frame 31, the cap 32) can be stored in the other part storage portion 80 (see FIGS. 3 and 4).

The lower engagement portions 95 and 97 of the lower housing 50, and the upper engagement portions 96 and 98 of the upper housing 55 can be engageable with each other (see FIG. 1).

The lower engagement portions 95 provided in the second region 92 of the lower housing 50, and the upper engagement portions 96 provided in the second region 92 of the upper housing 55 can engage with each other at this point.

When the storage case 5 is in a closed state as described above, the optical fiber 101 can be inserted into the storage case 5 from the optical fiber insertion port 76a near the rear end of the boot 21, and can project to outside the storage case 5 from the optical fiber insertion port 76b on the other side. Accordingly, the insertion parts 20 stored in a line in the storage case 5 can be passed through the optical fiber 101 in the order of the line (in the order of the boot 21, the sleeve 22, the stop ring 23, the clip 24 and the spring 25).

Subsequently, a user can hook his finger around the tabs 54 and 58 of the storage case 5 to pull up the upper housing 55. Since the upper engagement portions 96 provided in the second region 92 of the upper housing 55 engage with the lower engagement portions 95 provided in the second region 92 of the lower housing 50, the portion of the second region 92 can be held so as not to be pulled up.

The upper housing 55 can be thereby bent along the plurality of small holes 94 in the border portion between the first region 91 and the second region 92 due to the force to pull up the upper housing 55 by the finger hooked around the tab 58, and the force to hold the upper housing 55 so as not to be pulled up by the upper and lower engagement portions 96 and 95. Accordingly, in the storage case 5, only the first region 91 is opened while the second region 92 is maintained in a closed state (see FIG. 2).

The parts for use in fusion splicing 10, 20, and 28 arranged in the first region 91 can be thereby removed from the storage case 5. The other connector parts 30 arranged in the second region 92 are still held in the storage case 5 in a closed state.

The ferrule-with-optical-fiber 10 integrated with the holding member 40 can be removed from the storage case 5. The rear end of the short optical fiber 18 of the ferrule-with-optical-fiber 10, and the distal end of the optical fiber 101 can be fusion-spliced by using an appropriate fusion splicing apparatus.

To perform the fusion splicing, the coating in a portion with required length at the rear end of the splicing extra length 18c of the short optical fiber 18, and the coating in a portion with required length at the distal end of the optical fiber 101 are first removed. Subsequently, the rear end of the short optical fiber 18, and the distal end of the optical fiber 101 are disposed facing each other. The short optical fiber 18 and the optical fiber 101 are aligned based on the position of a core or a clad. Thereafter, the fusion splicing is performed.

In this case, if the coating in the rear end portion of the splicing extra length 18c of the short optical fiber 18 has been removed in advance, it can save time to remove the coating. Thus, the operation time can be reduced. The reinforcement sleeve 28 constituted by the heat-shrinkable tube including a reinforcement member of metal or the like and thermoplastic resin can be attached to the fusion-spliced portion to reinforce the fusion-spliced portion.

The upper housing 55 of the storage case 5 can be further pulled up to release the engagement of the upper and lower engagement portions 96 and 95, so that the second region 92 can be opened (see FIG. 3). Accordingly, the other connector parts (the other parts) 30 arranged in the second region 92 can be removed from the storage case 5.

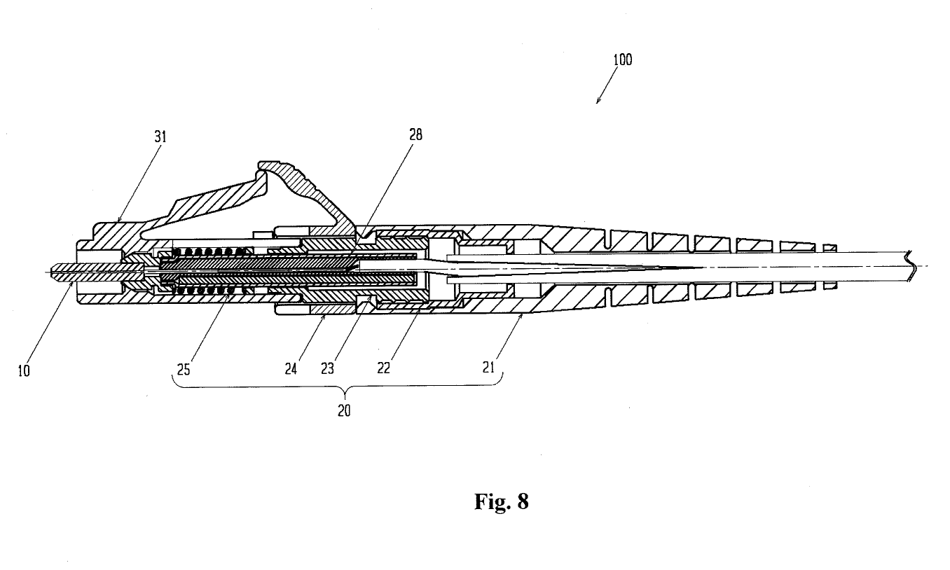

The insertion parts 20 passed through the optical fiber 101 (the boot 21, the sleeve 22, the stop ring 23, the clip 24, the spring 25) and the other connector parts (the other parts) 30 (the plug frame 31, the cap 32) are assembled in a predetermined assembling order. Accordingly, an optical connector 100 as shown in FIG. 8 is obtained.

The optical connector kit according to some embodiments has been specifically described above along with the optical connector assembling method using the optical connector kit. However, it should be noted that some embodiments are not limited to the aforementioned embodiment, and various design changes may be made therein.

For example, although not shown in the drawings, an opening and closing mechanism for the lower housing 50 and the upper housing 55 of the storage case 5 may employ any conventionally-known mechanism such as a hinge type mechanism or a fitting type mechanism. In this case, the storage case 5 may be also opened to the partially open state or the fully open state as needed.

Although the embodiments described herein are based on an LC type connector part, the embodiments may be adapted for any of an MU type, SC type, FC type connector parts or the like. Also, the embodiments can be adapted for other optical connectors not listed herein, but having similar structure.

Although this invention has been disclosed in the context of certain embodiments and examples, it will be understood by those skilled in the art that the present invention extends beyond the specifically disclosed embodiments to other alternative embodiments and/or uses of the invention and obvious modifications thereof. Thus, it is intended that the scope of the present invention herein disclosed should not be limited by the particular disclosed embodiments described above, but should be determined only by a fair reading of the claims that follow.

What is claimed is:

1. An optical connector kit comprising:
a ferrule with a first optical fiber made by mounting the first optical fiber into a ferrule and polishing an end surface of the first optical fiber;
a plurality of insertion parts to be passed through a second optical fiber in advance before a rear end of the first optical fiber and a distal end of the second optical fiber are fusion-spliced, wherein the first optical fiber is shorter than the second optical fiber; and
a storage case configured to store the ferrule with the first optical fiber and the insertion parts,
wherein the insertion parts are arranged in a line in the order in which the insertion parts are passed through the second optical fiber,
wherein the storage case comprises a lower housing and an upper housing in an openable and closeable manner,
wherein optical fiber insertion ports, through which the second optical fiber is configured to be inserted from outside on one side of the lower housing to outside on the other side of the lower housing through the insertion parts, are provided in both side walls of the lower housing,
wherein insertion part storage portions for storing the insertion parts are provided in both the lower housing portion and the upper housing portion, and
wherein the insertion parts are stored in the insertion part storage portions, and interposed between the lower housing portion and the upper housing portion.

2. The optical connector kit according to claim 1, wherein tapered shapes for guiding said second optical fiber to be inserted are formed between adjacent insertion part storage portions.

3. The optical connector kit according to claim 1, wherein the storage case comprises the lower housing having a bottom surface raised by a surrounding side wall and the upper housing having a lid surface to be coupled together in an openable and closeable manner,
wherein the lower housing comprises a flange around a lower portion of the side wall,
wherein the upper housing comprises a flange in a surrounding portion, and
wherein the upper housing and the lower housing comprise a lower engagement portion and an upper engagement portion engageable with each other.

4. The optical connector kit according to claim 3, the flanges of the lower housing and the upper housing are not brought into close contact with each other when the storage case is closed, so as to be a tab when the storage case is opened.

5. The optical connector kit according to claim 4, wherein a storage portion for the ferrule with optical fiber and a storage portion for the insertion parts are formed so as to bulge downward in the bottom surface of the lower housing, and
wherein a bulging depth of the storage portion for said individual insertion part is smaller than a height of said corresponding insertion part to be stored therein.
